(19) United States
(12) Patent Application Publication
(10) Pub. No.: US 2006/0190555 A1
(43) Pub. Date: Aug. 24, 2006

(54) Wrapping non-live objects for liveness

(75) Inventors: Thomas P. Moran, Palo Alto, CA (US); Beverly Harrison, Menlo Park, CA (US); Andreas Dieberger, Los Gatos, CA (US); Alex Cozzi, San Jose, CA (US); Michael Muller, Medford, MA (US); Andrew L. Schirmer, Andover, MA (US); Daniel M. Gruen, Newton, MA (US); Werner Geyer, Boston, MA (US)

Correspondence Address: CAREY, RODRIGUEZ, GREENBERG & PAUL, LLP;STEVEN M. GREENBERG, 1300 CORPORATE CENTER WAY, SUITE 105G, WELLINGTON, FL, 33414, US

(73) Assignee: International Business Machines Corporation, Armonk, NY (US)

(21) Appl. No.: 11/040,427

(22) Filed: Jan. 21, 2005

(51) Int. Cl. G06F 15/16

(52) U.S. Cl. 709/217

(57) ABSTRACT

A method, system and apparatus for wrapping objects for liveness in a collaborative environment. In a preferred aspect of the present invention, a method for enabling liveness for a non-live object can include the step of wrapping the non-live object to emulate liveness in a collaborative environment. Preferably, the wrapping step can include selecting at least one attribute of the non-live object, repeatedly updating a status of the at least one attribute for the non-live object, and, providing the repeatedly updated status to the collaborative environment in order to emulate liveness for the non-live object.

### BACKGROUND OF THE INVENTION

1. Statement of the Technical Field

The present invention relates to the field of collaborative computing and more particularly to the status awareness of objects in a collaborative computing environment.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

To facilitate collaborative aspects of a process, collaborative environments often incorporate the concept of a “live name”. A live name is a reference within the collaborative environment to a collaborator which indicates the presence of the collaborator associated with name. For example, the live name can indicate whether the collaborator has “logged in” or whether the collaborator has not utilized the collaborator's computer for some time—an idle state. Live names may also provide additional information about the person whose name appears. For example, in an organizational setting, a user may query on a live name in order to see the job title of the named collaborator, or to communicate with the named collaborator. Live names have been most widely utilized in the collaborative chat tool where it can be helpful to know whether a collaborator is available for an online discussion, and to be able to invoke a chat by a simple operation performed upon the collaborator's name.

As an extension of the live name concept, the “live object” can provide similar, collaborative advantages. A live object refers to a reference within the collaborative environment to a document which indicates the current status of the document, for example whether or not the document is in use. The live object also can indicate the identity of a collaborator using the document. In this way, collaborators need not work in isolation towards a common goal. Rather, a team environment can be promoted by the awareness of the presence and activities of fellow collaborators in a collaborative environment.

Notwithstanding the effective notion of a live name or live object, online collaborations seldom are limited to preconfigured live objects. Rather, in many circumstances, collaborators utilize garden variety objects such as documents and files which are created outside of the collaborative environment which supports “liveness”. Accordingly, an awareness of the state of a non-live object and the application of actions based upon the state of non-live actions can arise only manually through the multiple observations of different states of different objects and collaborators. Consequently, in many circumstances, important conditions can go unrecognized.

### SUMMARY OF THE INVENTION

The present invention addresses the deficiencies of the art in respect to live objects and provides a novel and non-obvious method, system and apparatus for wrapping objects for liveness in a collaborative environment. In a preferred aspect of the present invention, a method for enabling liveness for a non-live object can include the step of wrapping the non-live object to emulate liveness in a collaborative environment. Preferably, the wrapping step can include selecting at least one attribute of the non-live object, repeatedly updating a status of the at least one attribute for the non-live object, and, providing the repeatedly updated status to the collaborative environment in order to emulate liveness for the non-live object.

The selecting step can include the step of writing a reference to the non-live object and the attribute to an entry in a live object database. In this regard, the updating step can include determining a status for the attribute in the entry and writing the status to the entry. The providing step in turn can include the step of reading the status from the entry. Finally, the wrapping step can include introducing the non-live object into a unified activity manager, creating an activity in the unified activity manager, and inserting the non-live object as a resource in the created activity. For instance, the introducing step can include dragging-and-dropping the non-live object into the unified activity manager, or selecting the non-live object through a file system browser window and placing the selected non-live object into the unified activity manager.

Notably, the wrapping step can include the step of wrapping a non-live calendar item to add a completeness indicator to the calendar item. Also, the wrapping step can include the step of wrapping a non-live to-do item to add a time-of-day indicator to the to-do item. Finally, the wrapping step yet further can include the step of wrapping a non-live document to add a completeness indicator to the document.

A system for enabling liveness for a non-live object can include a collaborative environment configured to manage live objects. The system also can include a live wrapping processor programmed to wrap non-live objects to emulate live objects in the collaborative environment. In a particular aspect of the invention, the collaborative environment can be a unified activity manager.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative system configured for wrapping objects for liveness in a collaborative environment in accordance with the present invention;

FIGS. 2A and 2B, taken together, are a flow chart illustrating a process for wrapping and managing a live object in an unsupported collaborative environment;

FIG. 3A is a pictorial illustration of a process for inserting a wrapped live object in a unified activity manager collaborative environment; and,

FIG. 3B is a flow chart illustrating a process for inserting a wrapped live object in a unified activity manager collaborative environment.

### DETAILED DESCRIPTION OF THE PREFERRED EMBODIMENTS

The present invention is a method, system and apparatus for wrapping objects for liveness in a collaborative environment. In accordance with the present invention, non-live objects created outside of a collaborative environment configured for liveness can be wrapped with logic configured for liveness. The wrapper applied to the non-live object can be used to track the status of the non-live object and manage the reporting of the status to client processes so as to emulate the presence of a live object. Importantly, the collaborative environment can be a unified activity manager in which non-live objects from outside the unified activity manager can be placed within the unified activity manager and wrapped with an activity so as to become a live object within the unified activity manager.

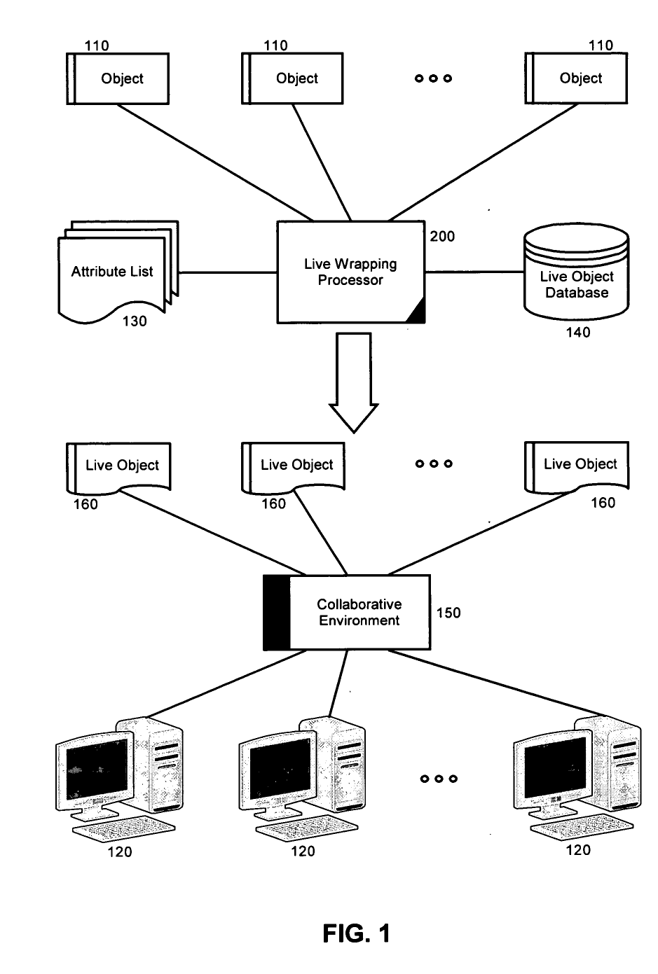

In more particular illustration, FIG. 1 is a schematic illustration of a collaborative system configured for processing live collections in accordance with the present invention. The collaborative system can include a collaborative environment 150 configured for coupling to one or more collaborators 120 over a computer communications network. The collaborative environment 150 can be configured to manage the incorporation of live objects 160, including persons, documents, events, actions, processes, and activities, each having “liveness”. Additionally, the collaborative environment can be configured to process non-live objects 110 wrapped for liveness utilizing a live wrapping processor 200.

Specifically, the live wrapping processor 200 can include logic programmed to select a particular one of the non-live objects 110 for wrapping. Once selected, attributes in an attribute list 130 can be chosen for tracking the state of the particular one of the non-live objects 110. Preferably, the identity of the particular one of the non-live objects 110 can be stored in a table 140 along with the selected attributes from the attribute list 130. Subsequently, the live wrapping processor 200 can monitor the state of the particular one of the non-live objects 110 according to the selected attributes in the table 140. The monitored state, in turn can be combined with the particular one of the non-live objects 110 to produce a live object 160 able to be utilized within the collaborative environment 150.

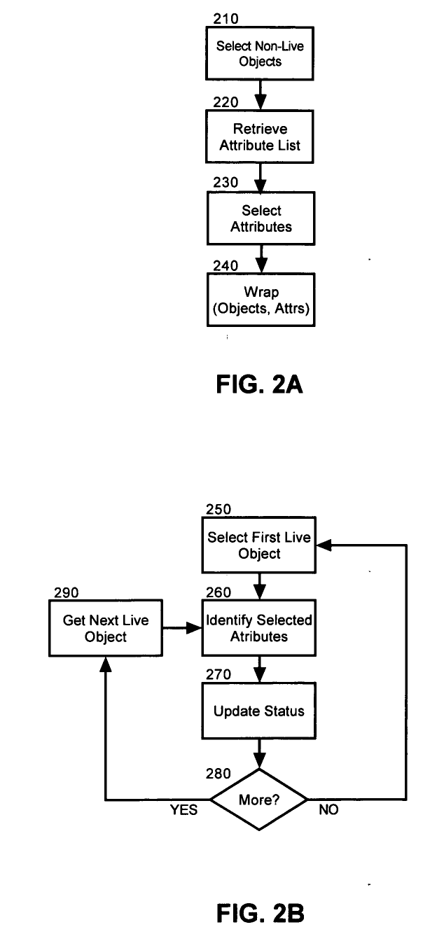

In further illustration, FIGS. 2A and 2B, taken together, are a flow chart illustrating a process for wrapping and managing a live object in an unsupported collaborative environment. First considering FIG. 2A, in block 210, a non-live object can be selected for wrapping into a live object. In block 220, a selection of available attributes can be retrieved. Subsequently, in block 230, one or more of the attributes can be selected for tracking in the non-live object. Finally, in block 240, the selected non-live object can be wrapped according to the chosen attributes. In this regard, preferably an entry can be written to a table or database which associates the identity and location of the non-live object with the selected attributes. Furthermore, the current state of the selected attributes can be periodically written to the entry.

Once a non-live object has been wrapped in accordance with FIG. 2A, the wrapped non-live object can be treated as a live object from within a collaborative environment. In this regard, the collaborative environment can trigger actions and events based upon the detected state of the live object. To that end, as shown in FIG. 2B, the state of the non-live object for the selected attributes can be periodically updated and reported to the collaborative environment so as to emulate a native live object. Specifically, in block 250 a first live object in the database as indicated by an entry to the database can be selected and in block 260, the attributes chosen for the live object can be identified. In block 270, the status of the non-live object named in the entry can be ascertained and updated in the database.

In decision block 280, if it is determined that additional live objects remain to be processed in the database, in block 290 a next live object can be selected for processing and the operations of blocks 260 through 290 can repeat. When all live objects referenced in the database have been processed with status updates, the process can begin anew for the first live object in block 250. Notably, by maintaining periodic updates of the attributes of the non-live objects referenced in the database, an appearance of a live object can subsist by mere reference to the database by the collaborative environment. Accordingly, several collaborative aspects can be added to the non-live objects when utilized within the collaborative environment.

For example, a completeness indicator can be added to a calendar item. Specifically, the completion status of “done” or “not done” can be associated with the calendar item so as to provide a more accurate, historical view of the calendar item. Also, a completion status can be added to a to-do when scheduled as a calendar item. A scheduled time-of-day and an alerting attribute can be added to a to-do item as well. In this way, the to-do can become a lightweight calendar item.

Notably, a completeness and awareness attribute can be added to a non-live document or shared work object. The completeness indicator can indicate whether or not the non-live document or shared work object has been completed. This can be particularly helpful when assembling compound documents. Additionally, a percent-complete indicator or an anticipated completion date indicator can be added to indicate to other collaborators how close the non-live document or work object is to completion. The awareness attribute, by comparison, can be used to track the actions of other collaborators in respect to the non-live document or work object.

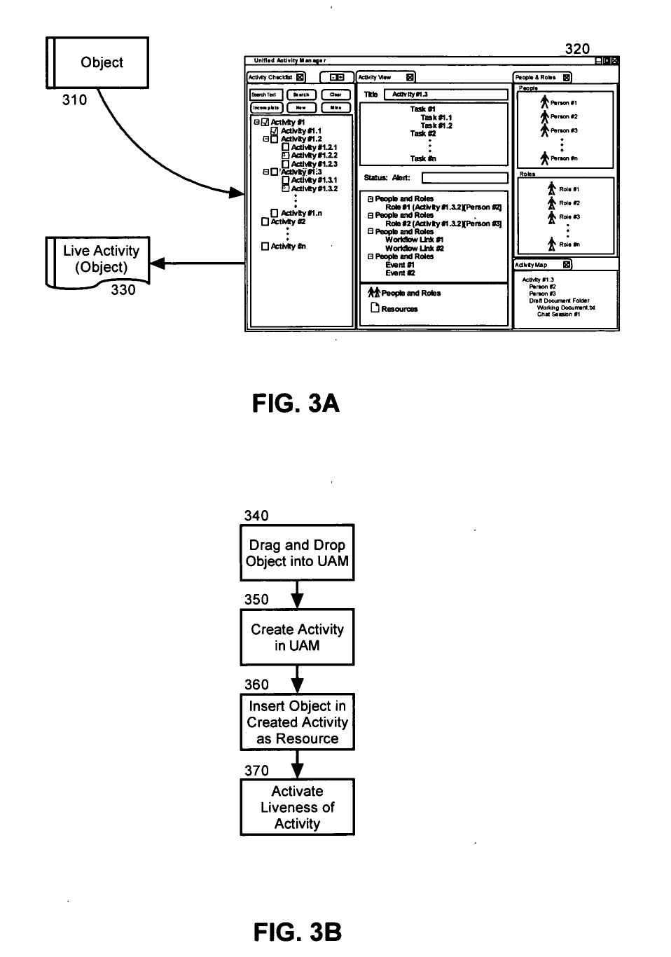

In a particular aspect of the invention, the collaborative environment can be a unified activity manager. To that end, FIG. 3A is a pictorial illustration of a process for inserting a wrapped live object in a unified activity manager. As shown in FIG. 3A, a unified activity manager 320 can include several views including an activity list view, an activity view and a people and roles view. The activity list view can include a listing of one or more activities. Each activity can be decomposed into zero or more dependent activities, which together comprise a richer description of the work summarized in the original activity. Each of these dependent activities is itself an activity, but appears in a sub-activity-relationship to the original activity. This process of defining activities in sub-activity-relationship may be extended to any desired level of dependent description.

The activity view can include a description of an activity task that is contained within the activity. The task description can include one or more activity tasks associated with the activity. Additionally, activity tasks can be decomposed into zero or more dependent activity tasks, which together comprise a richer procedural specification of the original activity task. Each of these dependent activity tasks is itself an activity task, but appears in a subtask-relationship to the original activity task. This process of specifying activity tasks in sub-task-relationship may be extended to any desired level of dependent specification.

The activity view further can include a detailed listing of the properties of a selected activity in the activity list view. Specifically, the detailed listing can include a listing of collaborators (people) specified for the activity. Also, the detailed listing can include a listing of collaborator roles (roles) specified for the activity. Further, the detailed listing can include a listing of events specified for the activity. Finally, the detailed listing can include a listing of links to internal workflows, external workflows or both.

The peoples and roles view can include a listing of collaborators in the collaborative environment available for assignment to a specified activity in the activity checklist view. The peoples and roles view also can include a listing of collaborative roles in the collaborative environment available for assignment to a specified activity in the activity list view. In this regard, a role can be compared to a person in that a person references a specific identity and a role references only a class of persons. Finally, an activity map can be provided. The activity map can include a hierarchically arranged set of electronic mail messages, calendar entries, documents, files and file folders, and applications, such as an application share, discussion thread or chat session, to name a few.

In accordance with the present invention, an object 310 lacking liveness can be placed within the user interface of the unified activity manager 320—for example through the use of a drag-and-drop operation. When placed within the user interface of the unified activity manager 320, the non-live object 310 can be inserted into an activity 330 having liveness as a quality. As such, the activity 330 can act as a wrapper to the non-live object 310 in the unified activity manager 320 in order to emulate the direct liveness of the non-live object 310.

More particularly, FIG. 3B is a flow chart illustrating a process for inserting a wrapped live object in a unified activity manager collaborative environment. Beginning in block 340, a non-live object can be placed in the unified activity manager through a drag-and-drop operation. In block 350, responsive to the drag-and-drop operation, an activity can be created in the unified activity manager. Subsequently, in block 360 the non-live object can be created within the activity as a resource to the activity. Finally, the liveness of the activity can be activated within the unified activity manager so that the status of selected attributes for the non-live object wrapped by the activity can be provided to subscribing viewers just as if the non-live object had been a live object in the unified activity manager.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for enabling liveness for a non-live object, the method comprising the step of wrapping the non-live object to emulate liveness in a collaborative environment.

2. The method of claim 1, wherein said wrapping step comprises the steps of:
selecting at least one attribute of the non-live object;
repeatedly updating a status of said at least one attribute for the non-live object; and,
providing said repeatedly updated status to said collaborative environment in order to emulate liveness for the non-live object.

3. The method of claim 2, wherein said selecting step comprises the step of writing a reference to the non-live object and said at least one attribute to an entry in a live object database.

4. The method of claim 3, wherein said updating step comprises the steps of:
determining a status for said at least one attribute in said entry; and, writing said status to said entry.

5. The method of claim 4, wherein said providing step comprises the step of reading said status from said entry.

6. The method of claim 1, wherein said wrapping step comprises the steps of:
introducing the non-live object into a unified activity manager;
creating an activity in said unified activity manager; and,
inserting the non-live object as a resource in said created activity.

7. The method of claim 6, wherein said introducing step comprises the step of dragging-and-dropping the non-live object into said unified activity manager.

8. The method of claim 6, wherein said introducing step comprises the step of selecting the non-live object through a file system browser window and placing said selected non-live object into said unified activity manager.

9. The method of claim 1, wherein said wrapping step comprises the step of wrapping a non-live calendar item to add a completeness indicator to said calendar item.

10. The method of claim 1, wherein said wrapping step comprises the step of wrapping a non-live to-do item to add a time-of-day indicator to said to-do item.

11. The method of claim 1, wherein said wrapping step comprises the step of wrapping a non-live document to add a completeness indicator to said document.

12. A system for enabling liveness for a non-live object, the system comprising:
a collaborative environment configured to manage live objects; and,
a live wrapping processor programmed to wrap non-live objects to emulate live objects in said collaborative environment.

13. The system of claim 12, wherein said collaborative environment is a unified activity manager.

14. A machine readable storage having stored thereon a computer program for enabling liveness for a non-live object, the computer program comprising a routine set of instructions which when executed by a machine causes the machine to perform the step of wrapping the non-live object to emulate liveness in a collaborative environment.

15. The machine readable storage of claim 14, wherein said wrapping step comprises the steps of:
selecting at least one attribute of the non-live object;
repeatedly updating a status of said at least one attribute for the non-live object; and,
providing said repeatedly updated status to said collaborative environment in order to emulate liveness for the non-live object.

16. The machine readable storage of claim 15, wherein said selecting step comprises the step of writing a reference to the non-live object and said at least one attribute to an entry in a live object database.

17. The machine readable storage of claim 16, wherein said updating step comprises the steps of:
determining a status for said at least one attribute in said entry; and,
writing said status to said entry.

18. The machine readable storage of claim 17, wherein said providing step comprises the step of reading said status from said entry.

19. The machine readable storage of claim 14, wherein said wrapping step comprises the steps of:
introducing the non-live object into a unified activity manager;
creating an activity in said unified activity manager; and,
inserting the non-live object as a resource in said created activity.

20. The machine readable storage of claim 19, wherein said introducing step comprises the step of dragging-and-dropping the non-live object into said unified activity manager.

21. The machine readable storage of claim 19, wherein said introducing step comprises the step of selecting the non-live object through a file system browser window and placing said selected non-live object into said unified activity manager.

22. The machine readable storage of claim 14, wherein said wrapping step comprises the step of wrapping a non-live calendar item to add a completeness indicator to said calendar item.

23. The machine readable storage of claim 14, wherein said wrapping step comprises the step of wrapping a non-live to-do item to add a time-of-day indicator to said to-do item.

24. The machine readable storage of claim 14, wherein said wrapping step comprises the step of wrapping a non-live document to add a completeness indicator to said document.
